(19) United States
(12) Patent Application Publication
(10) Pub. No.: US 2004/0103014 A1
(43) Pub. Date: May 27, 2004

(54) System and method for composing and constraining automated workflow

(76) Inventors: Hugh A. Teegan, Bellevue, WA (US); Vijay Mital, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/304,589

(22) Filed: Nov. 25, 2002

(51) Int. Cl. G06F 17/60

(52) U.S. Cl. 705/8

(57) ABSTRACT

Workflows can be used, created, modified and saved from within the user's working environment. Workflow can be initiated by selecting actions from a menu or workflow can be triggered by actions of users. A workflow, including an in progress workflow, can be dynamically modified, for example, to fix a process that has gone awry, to change the workflow to accommodate a changing situation, or the like. An existing workflow saved as a practice may be reused or modified. A composition system builds workflows by combining workflow units within limitations imposed by a constraint system. A constraint system accesses information stored in a knowledge base to restrict the actions an initiator of an action can initiate within a particular context in the workflow or in the environment in which the workflow operates, the targets the initiator can assign a task to, and the resources with which the initiator can associated a task.

### FIELD OF THE INVENTION

The invention relates generally to the field of computing. More particularly, the invention provides a system and method for automating workflow.

### BACKGROUND

Before workflow automation, workflow typically was implemented manually. A participant in a workflow typically reviewed a file containing forms and documents, filled out a form and routed the form and documents to the next workflow participant. There was no easy way to track the status of a task or to find tasks that were late or lost in the process, or to determine the cost of the process.

Personal computers, networks and e-mail have made the automation of workflow practical and attractive. Intelligent electronic forms can replace paper forms, databases can store vast amounts of information and e-mail provides an easy, cheap and almost instantaneous means of routing information.

In the world of automated workflow, most people think about workflow as an automated set of repeatable actions that implement a business process and optimally, increase efficiency. A more formal definition might be an automated task performed in series or in parallel by two or more members of a workgroup to reach a common goal. Business process automation therefore refers to the use of computer-based information technology to automate the steps in a business process, coordinate the assignment and distribution of workflow items and information among individuals and manage the completion of business processes. Expense reporting, budget negotiation or product specification and review are some of the processes that might be automated by an automated business process or workflow system.

A budget process, for example, may involve people working together to develop a spreadsheet that reflects the cost of business for an upcoming financial year. To automate the budget process, a system ideally would define the more formal steps in the process, facilitate the more informal interactions, provide an up-to-date status of the flow and capture the knowledge of human workers with respect to reaction to changes and exceptions. Typically, however, automated workflow systems capture explicit actions that people take as part of a workflow, but provide very little flexibility, and do not permit people participating in the workflow to deal with exceptions and changes of circumstances by acting in ways different from the explicit actions. The result is that real-world human workflows are not adequately modeled in automated workflow systems.

In addition, current workflow systems typically are static in nature. An activity or task that a workgroup needs to perform is typically defined by a process specialist who breaks the task into steps governed by set business rules. The flow of steps within the task is mapped and job functions or individuals are associated with each step. A programmer then transforms the analyzed task into a static executable unit. If the nature of the task changes, however, a programmer must change the executable unit. A non-programmer cannot add new workflow units or change existing ones. Hence, workflow systems available today are limited and inflexible and generally are used only by clerical or line workers whose actions can be confined to that which is pre-defined and pre-determined. Also all but the most rigid and unchanging of organizations find it a huge effort to keep workflows up to date with the reality.

It would be helpful if there were a flexible workflow system that non-programmers and non-process specialists could use to create workflows, and to modify a pre-defined workflow in progress and thus adapt workflows over time to changes in the organization, business and the overall environment. Further it would be helpful to have a workflow system that can monitor what people actually do as part of their day-to-day activities and from that discover workflows and permit those discovered workflows to be saved, with or without modification, for future use, thus creating workflows from the actions that people take rather than from a designed workflow.

### SUMMARY OF THE INVENTION

The present invention provides systems, methods and computer-readable media to create a set of systems that enable a user who is not required to have programming skills to use, create, modify and save workflows within the user's working environment. Workflow can be initiated by selecting actions from a menu or simply by the user performing his duties, (i.e., workflow can be discovered from the actions of users, such as, for example, sending an e-mail message). A workflow can be dynamically modified, for example, to fix a process that has gone awry, to change the workflow to accommodate a changing situation, or the like. An existing workflow saved as a practice may be reused or modified. A composition system or service composes workflow units called actions into workflows. An optional constraint system or service imposes limitations. A constraint service accesses information stored in a knowledge base to restrict the actions that can be added during the creation of the workflow or during modification of an in progress workflow.

### BRIEF DESCRIPTION OF THE DRAWINGS

The foregoing summary, as well as the following detailed description of embodiments of the invention, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing environment in which aspects of the invention may be implemented;

FIG. 2 is a block diagram of a system for composing workflows in accordance with one embodiment of the present invention;

FIG. 3 is a block diagram of an exemplary workflow in accordance with one embodiment of the present invention;

FIG. 4 is a block diagram illustrating a model for composition of an exemplary workflow in accordance with one embodiment of the present invention;

FIG. 5 is a flow diagram of a method for performing workflow in accordance with one embodiment of the present invention; and

FIG. 6 is a flow diagram of a method for constraining workflow in accordance with one embodiment of the present invention.

### DETAILED DESCRIPTION OF THE INVENTION

Exemplary Computing Environment

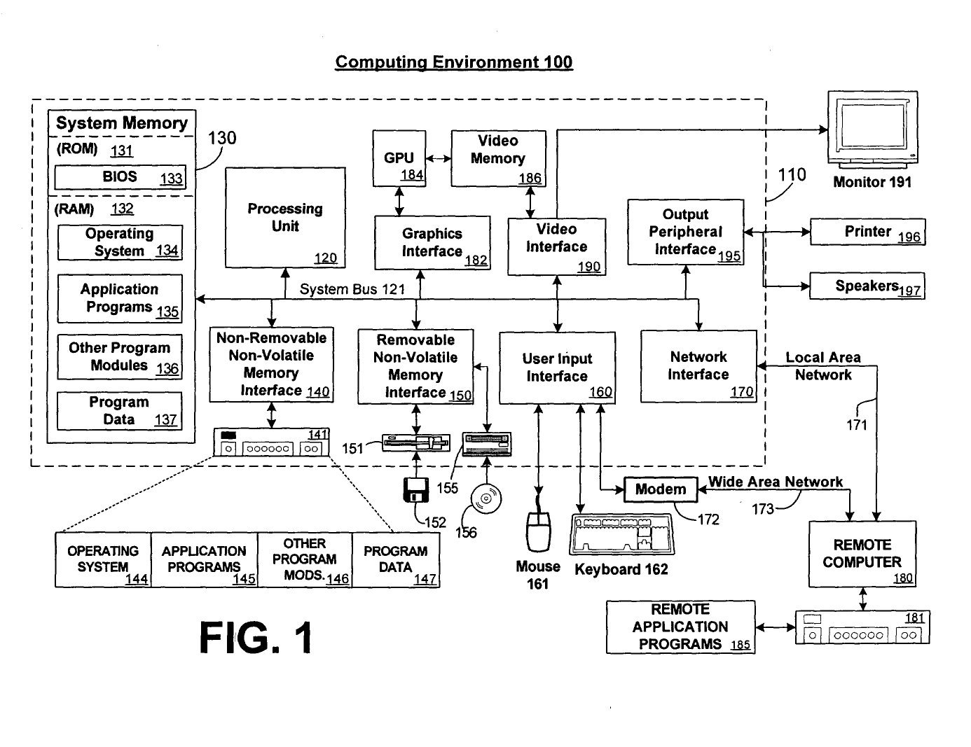

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted systems in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147.

Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

System and Method for Automating Workflow

Workflow may be considered to be a set of actions that take place between people or processes or a combination thereof. A workflow system in accordance with one embodiment of the present invention may capture and record one or more tasks performed by an actor and encapsulate them into a workflow. The resources used by an actor during performance of the task, and any successive or parallel flows of information between actors may also be included in the workflow. A workflow may be saved to be used again. A workflow system in accordance with one embodiment of the present invention may enable workflow to be created and used by those who participate in performing the work. The workflows thusly created may become part of the workflows generally available enterprise-wide and may be incorporated into practices. The practices may be used “as is” or may be further modified.

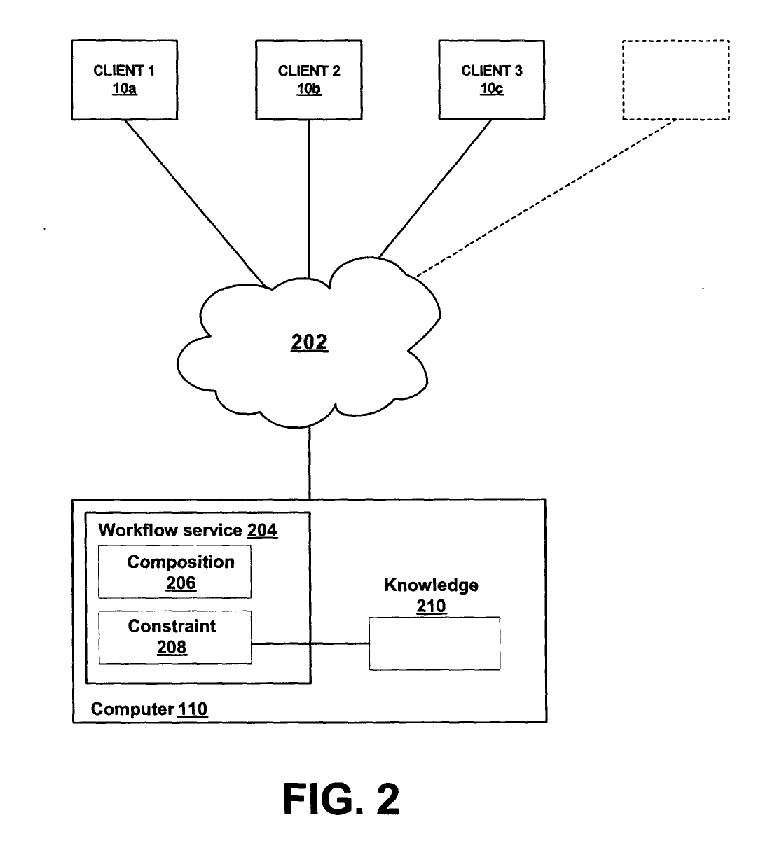

FIG. 2 is a block diagram of a system for composing workflows in accordance with one embodiment of the present invention. Clients 10a, 10b, 10c, etc. may be communicatively coupled to a computer 110 via a network 202. Clients 10a, 10b, 10c, etc. may be remote computers and may be personal computers, servers, routers, network PCs, peer devices or other common network nodes, and typically includes many of the elements described above with respect to computer 110. Network 202 may be a LAN, WAN or other suitable networks commonly found in offices, enterprise-wide computer networks, intranets and the Internet. It will be appreciated that the network connections shown are exemplary and other means of establishing a communications link between the computers may be used. In addition, not all the illustrated components may reside in all embodiments and some of the services may be optional or missing in certain embodiments. So, although the description below may describe the services together, they should not be considered as required by all embodiments. For example, only constraint service 206 may not reside in some embodiments. Similarly the constraint service may be applied to workflow services that are different than those described here and still fall within the scope of the invention. Workflow system 204 residing on computer 110 includes composition system 206. Composition system 206 may include a composer (not shown) that encapsulates one or more actions, actors and resources, if needed into a workflow. In one embodiment of the invention, workflow system 204 also includes constraint system 208 and knowledge base 210. Although composition system 206, constraint system 208 and knowledge base 210 are shown in FIG. 2 as residing on the same computing device, composition system 206, constraint system 208 and knowledge base 210 may in fact reside on different computing devices, in varying combinations of a single service may be distributed across multiple systems. Workflow system 204 may initiate many different workflows based on the requests of clients 10a, 10b, 10c, etc. Workflow system 204 may be explicitly instantiated by a process or by an application functionality or it may be implicitly instantiated by actions taken within another operation. Each time workflow system 204 receives a message corresponding to an activation operation, a new workflow instance is created. A workflow terminates when the tasks within the workflow are completed or when particular types of interrupt messages are received.

A composition system combines units of workflow called actions into workflows, recording and encapsulating the tasks performed by an actor, resources used, if any, and successive and parallel flows of information between actors and converting these elements into a workflow unit. A constraint system may restrict the operations that an actor is allowed to do to extend or modify a workflow. The restrictions are obtained through a set of business policies that the constraint system can access. The constraint system in one embodiment accesses the knowledge base to obtain role information about users, and the reporting structure of the users within the organization. The constraint system may ascertain the complexity and correctness of a workflow and restrict the actions that can extend or modify the workflow. Alternatively or additionally, the constraint system may access information concerning the organizational hierarchy, etc. from the knowledge base to further constrain the workflow. For example, when a person is designing or modifying a workflow and seeks to add a particular kind of action that will be performed by a particular kind of actor, the constraint system may determine the role in the organization of the actor and constrain the list of available actions allowed for the actor's role, thus eliminating wrong workflows. Conversely, when the person designing or modifying a workflow adds a particular action, the constraint system may determine from the knowledge base a list of actors in the organization who are permitted to perform that action, so that the designer may select only valid actors. Similarly/additionally/alternatively, the workflow may be constrained based on knowledge about the resource type required for the workflow process. As another example, the constraint system may refer to the knowledge base for rules or precedents on the types of workflow structures that are hard to understand, such as workflows that go back and forth between the same pair of participants a number of times, or workflows that are prone to failure, such as workflows in which multiple people are dependent on the action of a single person and no alternative path is defined on default by that single person. In the case of an in progress workflow, the constraint system may interpret the conditions that the workflow is operating currently, prior to modification, and then either prohibit or advise against such actions being added as will violate the conditions.

Hence the constraint system operates during the creation or modification of a workflow, including the modification of an in progress workflow, to determine the particular actions that can or cannot be added or removed, the actors that can be the targets of particular actions, and the resources that can be used by actions. The constraint system may rely on the knowledge base to obtain user profile information and roles associated with the user, and any specifically expressed constraints that restrict the initiator and targets for each action, so that the constraint system can determine all the users in a specified role and all the roles that a specified user may assume.

A specifically expressed constraint can be of the form: given an actor, action type and step sequence, restrict the targets of the action instance at runtime. The constraint system may rely on the knowledge base to obtain the resources that may be used within an action, with specifically expressed constrained similar to those described for roles and actions. Other constraints may be defined to restrict the workflow structures and shapes that should be prohibited or advised against. A knowledge base 210 may be a repository of information about actors and business policies, about resources and actions, and about the structures or shapes of interaction within a workflow that can cause failure or other problems, and may be implemented as a file, database or other suitable data store. The information stored in the knowledge base may indicate the role and attributes of an actor. The knowledge base may also provide hierarchical information so that the relative positions of actors within an organization can be determined. The knowledge base in one embodiment of the invention includes the MICROSOFT ACTIVE DIRECTORY, however any directory or role service or database may be used. The knowledge base may be used to constrain (e.g., limit or restrict) workflow, as further described below.

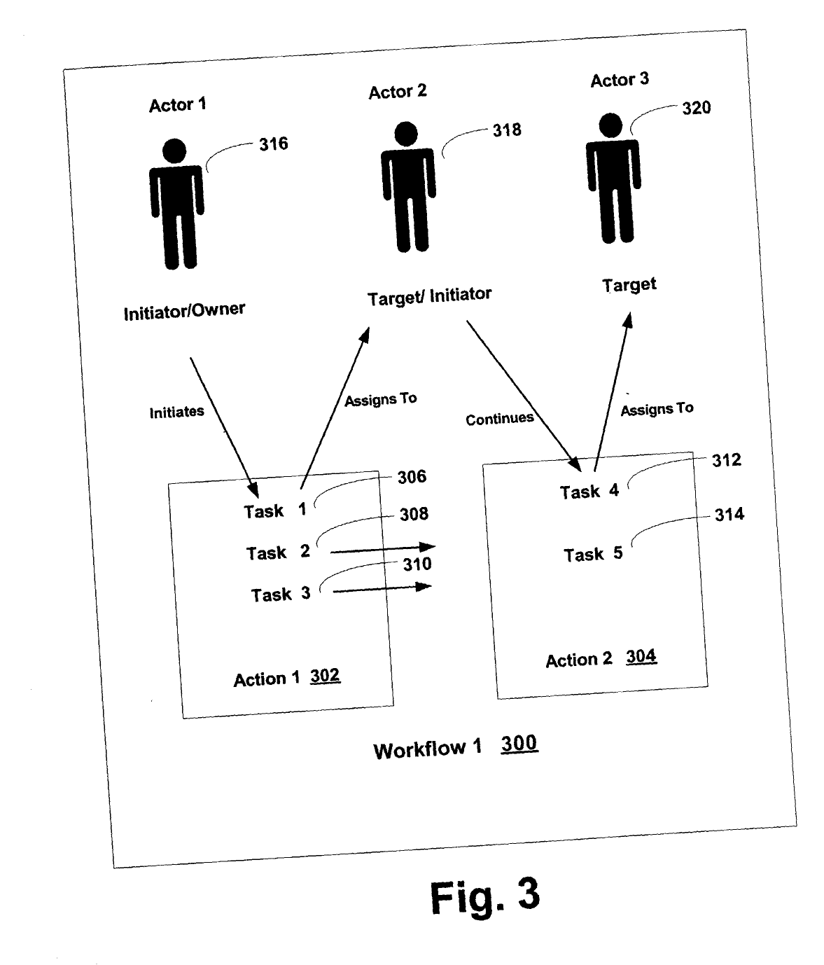

FIG. 3 is a block diagram illustrating the basic model of a workflow system in accordance with the invention. A workflow 300 includes one or more actions such as Action 1 302 and Action 2 304.

An action such as Action 1 302 and Action 2 304 is a unit of workflow. An action such as Action 1 302 and Action 2 304 may contain one or more tasks. For example Action 1 302 includes Task 1 306, Task 2 308, and Task 3 310, and Action 2 304 includes Task 4 312 and Task 5 314. Tasks define work that needs to be done by the participants (actors) in the workflow. A task is an interface between an action and an actor and communicates what needs to be done by the actor as part of the workflow. An actor such as Actor 1 316, Actor 2 318 and Actor 3 320 is an external entity that either initiates a workflow or participates in a workflow. An actor can be an initiator or a target. An actor who initiates an action is called the owner of the workflow. For example, Actor 1 316 has initiated Action 1 302 and is the initiator and owner of Action 1 302 and has assigned Task 1 306 to Actor 2 318, who is the target of Task 1 306. Actor 2 318 has initiated Action 2 304 and thus is the initiator of Task 4 312 and has designated Actor 3 320 as the target of Task 4 312. An action can be initiated by an actor or by a process. An actor may associate a resource to an action within a workflow, disassociate a resource from an action within a workflow and/or return a resource description given an action and a workflow.

In one embodiment of the invention, an initiator of an action may specify parameters as follows with various of the parameters being missing or optional depending on the specific embodiment: the target or targets of the action, whether the action is to be performed in series (e.g., after a task is performed by the first target it can be performed by the next target) or in parallel (e.g., a task can be performed by the first target and the second target at the same time). An initiator of an action may also specify a time-out period within which the action must be performed.

For example, an employee (actor/initiator/owner of the action, e.g., Actor 1 316) may initiate an expense approval (action, such as Action 1 302) for an expense report. The initiator/owner (e.g., Actor 1 316) may name the employee's manager (actor/target, e.g., Actor 2 318) as the approver. A task (e.g., Task 1 306) has now been generated because an action has been associated with a target. The employee (actor/initiator/owner of the action, e.g., Actor 1 316) may select his manager's assistant (actor/target, not shown) as reviewer (thus generating a second task, e.g., Task 2 308) and a finance person (actor/target, not shown) as controller (thus generating a third task, e.g., Task 3 310). The first target (i.e., the manager, Actor 2 318) may proceed to complete the requested task. The first target (manager, Actor 2 318) may decide to initiate another action as part of the workflow. The first target (manager, Actor 2 318) may approve the expense report or may delegate (another action, e.g., Task 4 312) the report to his substitute (actor/target, e.g., Actor 3 320). The expense report may be approved or denied once the tasks have been completed.

In one embodiment of the invention, an action is implemented as an XLANG schedule. XLANG is a language for expressing process. XLANG creates a high level abstraction of process modeled as the sending and receiving of messages asynchronously. The basic constituents of an XLANG process definition are actions. XLANG actions include request/response, solicit response, one way, notification, deadline and duration. An XLANG schedule in one embodiment of the invention conforms to an action template (e.g., a MICROSOFT VISUAL STUDIO project template or other template). In one embodiment of the invention, messages are used to start, stop, abort and rollback actions. A message may also be used to synchronize operation of one action with another action. In one embodiment of the invention, a message is formally defined by a schema, such as but not limited to an XML schema. Actions such as Action 1 302 and Action 2 304 may include an initial set of pre-defined steps with which is associated application-specific knowledge useful to automate tasks and to assign tasks to actors. A message may include type, identification and configuration sections.

The type section of the message identifies the message type. Message types include an initialize message (used to initiate actions), a synchronize message (used to communicate between actions), an interrupt message (which causes an action to fault by enabling stop, abort and rollback actions), a task message, used by an action to communicate with an actor via a task and a finish message that indicates that the action has completed either successfully or because of an exception condition.

The identification section of the message provides the Universal Resource Identifier (URI) of the action which is about to be acted on, the URI of the container workflow if it exists and the URI of the predecessor action if a predecessor action exists.

The configuration section specifies if the action is to be executed immediately or if the execution is to be delayed. If the message is an interrupt type of message, the configuration section defines the interrupt type.

Each action may include the following for an activation (described below): an actor part including workflow identification code, a predecessor action identification code, an independent or dependent composition and target actors; and an action part including input parameters. Output messages include an actor part including workflow identification code, action identification code, and target actors and an action part including message specific information.

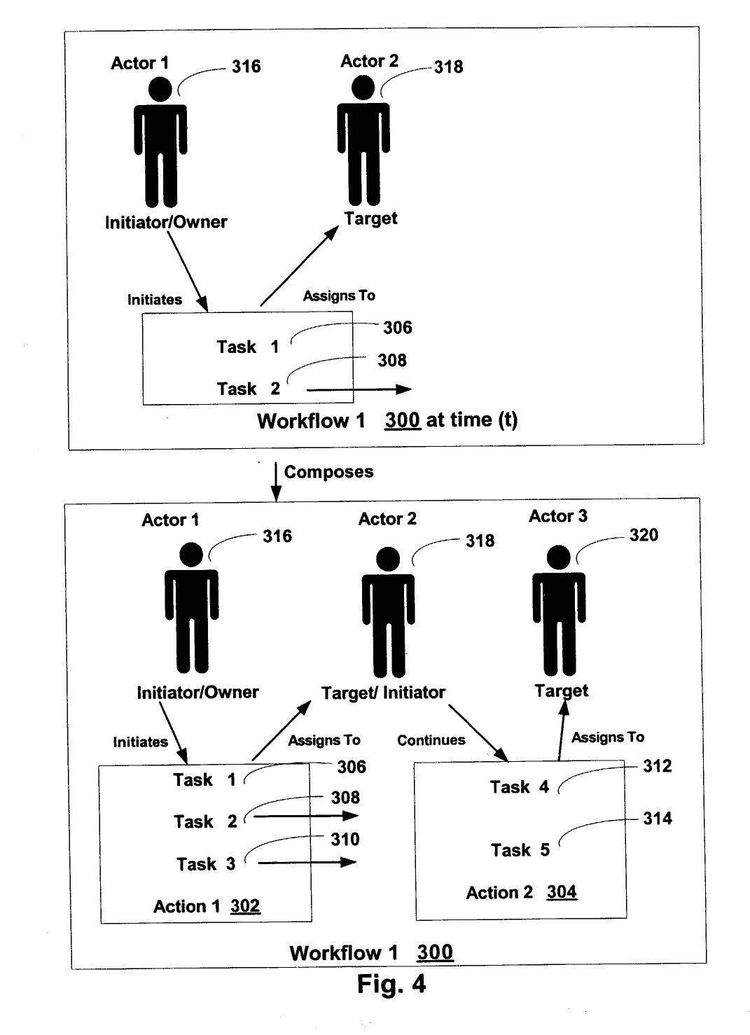

Composition refers to the process of creating a workflow from one or more actions. A workflow can be saved so that the workflow can be executed again (a saved workflow may be referred to as a practice). FIG. 4 is a block diagram of a model for composition in accordance with one embodiment of the invention. FIG. 4 shows Actor 2 318 who is a target in a workflow 300 initiated at time (t), continuing an Action 2 304 by, for example, submitting action parameters using a user interface. Action 2 304 is then composed with the previous action, Action 1 302 as part of the same workflow 300. Workflow 300 at time (t+1) shows the resultant continuing workflow after composition.

In one embodiment of the invention, a composition system performs composition by dynamically composing actions into workflows. Composition can be expressed as two or more pieces of XLANG which are examined to see if the two pieces can compose, that is, if the two pieces of process can be combined to create one larger piece of process. A composition protocol, for example, may specify the format of process outputs (e.g., how a message is sent out for composition) and the initial step or series of steps in each process in the composition set.

Composition may allow actions to be added to existing workflows, and actors and resources to be associated with actions, subject to the constraints imposed by the constraint system, and may load and save practices and execute the workflow. Composition is performed subject to the following possible limitations imposed by the constraint system: constraints may be introduced by the owner of a workflow to allow or disallow further compositions; constraints may be associated with an actor who wants to add an action (e.g., an action may not be visible for adding to the workflow); constraints may be further refined and be associated with an actor within a particular context of the position in the workflow at which the action is sought to be added or of any particular context of circumstances existing in the environment in which the workflow operates; constraints may be associated with actions restricting predecessor or successor actions; and constraints may be associated with the role or identity of the person who seeks to add an action, or the predecessor persons who may have added or initiated actions. A constraint may be defined to restrict the initiator and targets for the actions within the practice. In one embodiment of the invention, the constraint may be of the form, given an actor, action and step sequence, restrict the targets of the action instance. A practice may be set to be immutable so that no ad-hoc composition to the actions within the practice may be made.

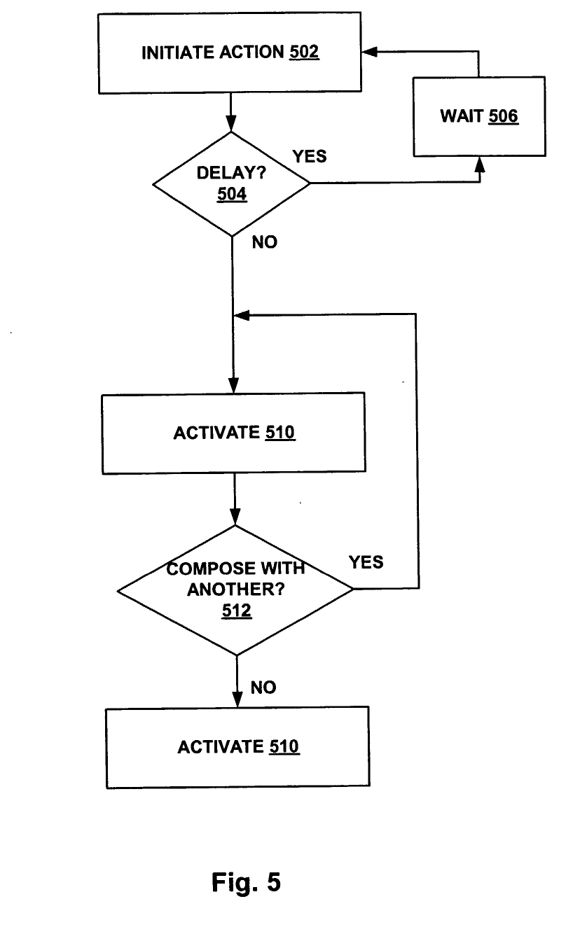

FIG. 5 is a flow diagram of a method of composing workflows in accordance with one embodiment of the invention. At step 502, an action is initiated. An actor may initiate an action by submitting action parameters using a user interface. Alternatively, an action may be initiated by a process in accordance with an established practice template. In one embodiment of the invention, an action can be initiated by sending an e-mail message. In one embodiment of the invention, an initiation of an action may result from the presence of certain keys or cues present in an external process, such as cues found in an e-mail message. For example, the presence of the words “action items” followed by a colon and a list present in an e-mail message may cue the workflow system to initiate one or more actions. Any suitable cues may be used to trigger the initiation of an action.

At step 504 it is determined if composition is to proceed immediately or is to be delayed. In one embodiment of the invention, the initiate action message may include a “compose now” or “delay composition” indicator. If composition is to proceed immediately, processing continues at step 508. If composition is to be delayed, processing continues at step 506. At step 506, in one embodiment of the invention, processing of the action pauses until a synchronization message is received. When the synchronization message is received, processing continues.

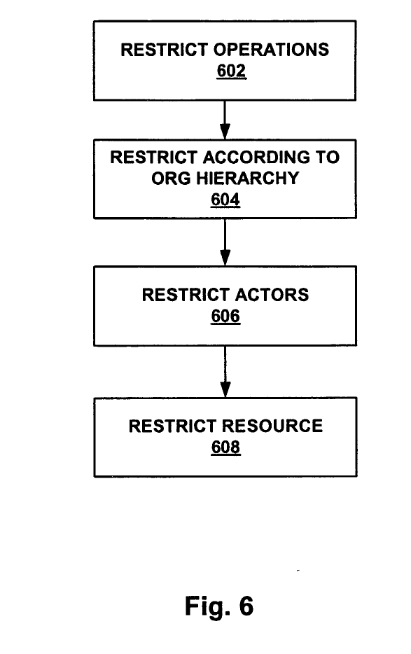

Optionally, constrains may be applied to limit the composition of the action using information stored in the knowledge base, as illustrated in FIG. 6. For example, constraints may be introduced by the owner of a workflow to allow or disallow further compositions; constraints associated with the actor who wants to initiate an action such as if the action is visible in a context or if the actor has the right to activate it; constraints associated with actions restricting predecessors or successors; and constraints associated with an actor that restricts the role as target or successive initiator are taken into account. The composition process may use the constraint sub-process to allow the execution of the actions within the workflow.

Referring again to FIG. 5, at step 510 the action is activated and an actor is assigned or associated with the action, creating a task.

At step 512 it is determined whether the action is to be composed with a predecessor action. In one embodiment of the invention, the initiate message includes a predecessor action identification code if the action is to be composed with another action. If the action is to be composed with another action, processing continues at step 508. If the action is not to be composed with another action, processing continues at step 514. In step 514 in one embodiment of the invention, the action or actions are encapsulated with the initiators and targets into a workflow.

Two actions can be composed if one of the possible outputs of a previous action corresponds with the input message of the second action. In one embodiment of the invention, the composition system uses XLANG to compose actions together, although any suitable language may be used.

The composition system may, for example, receive an instance identification code(s) of a predecessor action(s) and a workflow identification code from a client along with values of action specific parameters. The composition system also gets information about whether or not execution of the action should proceed immediately. This information is put into an activation message and sent to XLANG to compose the actions together. The instance identification code of the action that was activated is returned to the client.

In one embodiment of the invention, the composition system supports independent and dependent composition. Independent composition is used when an action is composed with another action for immediate execution or execution upon completion of a predecessor action. The composition system formulates areas of the initiating message, reflects on the initial input post of the action being composed to determine the additional input needed by the action, obtains the additional input from the composition system and initiates the action using the formulated message.

Dependent composition is used when an action is composed with another action for deferred execution depending on an output or outcome of a predecessor action. The dependent composition operates between actions using a synchronization message. The composition system sends an initialize message to the action being composed causing the action to wait for a specific instance of a particular message from the predecessor action. Composition continues when a successor action receives a synchronization message from the predecessor action.

Consider the following example of independent composition: assume a workflow includes an approval action that in one step of the process is sent to employee Hugh. Hugh must respond to the approval (approve or reject) within a 3-day window, (i.e., there is a 3-day time-out). If Hugh does not respond to the approval within the 3-day window, and a delegate action is composed after the 3-day time-out, to assign the approval action to another, this is an independent composition because the first (approval) process is deemed to have reached steady state.

Consider the following example of dependent composition: assume a workflow includes an approval action that in one step of the process is sent to employee Hugh. Hugh must respond to the approval (approve or reject) within a 3-day window, (i.e., there is a 3-day time-out). Now assume that sometime within the 3-day window (i.e., before the time-out period is reached), a delegate action is composed to assign the approval action to another, this is a dependent composition because the first (approval) process has not reached steady state. The delegate action will not take effect until the timer has timed out so the two pieces of process (approval and delegate) are composed but the second piece of process (the delegate) is dependent on an action that has not yet occurred. It should be understood that although in the example given, the dependency that arises is temporal, dependencies may arise because of other suitable considerations, (e.g., a dependency arises because an expense report to be approved exceeds a certain dollar amount.)

A practice defines a model by which workflows can be executed in a pre-defined manner. A practice may include one root action, for example, which is independently composed. The activation of this action at runtime signifies the start of execution of a practice. In addition, a practice can be configured to be immutable, thereby restricting composition to an action within the practice.

FIG. 6 is a block diagram of a constraint system in accordance with one embodiment of the invention. At step 602, a constraint service restricts the operations that an actor is allowed to do to extend or modify a workflow. In one embodiment the restrictions are obtained by accessing a set of business policies although other methods of restricting the operations are contemplated by the invention. At step 604 information concerning the organizational hierarchy may be accessed so that, for example, when a person is designing or modifying a workflow and seeks to add a particular kind of action that will be performed by a particular kind of actor, the role in the organization of the actor is checked so that the list of available actions allowed for the actor's role is constrained. At step 606 a knowledge base or other source of information may be accessed to determine a list of actors in the organization who are permitted to perform the action or operation, so that the workflow designer is able to select only valid actors. At step 608 the resource (if any) may be constrained based on knowledge about the resource type required for the workflow process. Additional steps may be included as described above. It will be understood that the steps may be performed in any logical order, and not all steps may be performed.

The methods and system described above may be embodied in the form of program code (i.e., instructions) stored on a computer-readable medium, such as a floppy diskette, CD-ROM, DVD-ROM, DVD-RAM, hard disk drive, or any other machine-readable storage medium, wherein, when the program code is loaded into and executed by a machine, such as a computer, the machine becomes an apparatus for practicing the invention. The present invention may also be embodied in the form of program code that is transmitted over some transmission medium, such as over electrical wiring or cabling, through fiber optics, over a network, including the Internet or an intranet, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits. The program code may be implemented in a high level programming language, such as, for example, C, C++, or Java. Alternatively, the program code may be implemented in assembly or machine language. In any case, the language may be a compiled or an interpreted language.

It is noted that the foregoing examples have been provided merely for the purpose of explanation and are in no way to be construed as limiting of the present invention. While the invention has been described with reference to preferred embodiments, it is understood that the words used herein are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A composition system for generating an automated business process comprising:
at least one action associated with an initiating actor;
a set of parameters associated with the at least one action; and
a composer that encapsulates the at least one action, and the set of parameters into the automated business process.

2. The system of claim 1, wherein the automated business process comprises a workflow.

3. The system of claim 1, wherein the at least one action comprises at least one task.

4. The system of claim 3, wherein the at least one task is associated with at least one target actor.

5. The system of claim 3, wherein the at least one task is associated with at least one resource.

6. The system of claim 1, wherein the set of parameters comprises at least one of:
a target actor, a timeout, and an indicator indicating that the action is to be performed in series.

7. The system of claim 1, wherein the set of parameters comprises at least one of:
a target actor, a timeout, and an indicator indicating that the action is to be performed in parallel.

8. The composition system of claim 4, further comprising a constraint system, the constraint system comprising:
a knowledge base for storing information concerning the initiating actor, the at least one target actor and the at least one task;
a constrainer that restricts at least one action and the set of parameters according to information stored in the knowledge base.

9. The system of claim 8, wherein the constraint system restricts the initiating actor.

10. The system of claim 8, wherein the constraint system restricts the at least one action associated with the initiating actor.

11. The system of claim 8, wherein the constraint system restricts the target actor with which the at least one task may be associated.

12. The system of claim 8, wherein the constraint system restricts a resource with which the at least one action may be associated.

13. The system of claim 8, wherein the knowledge base comprises hierarchical information concerning the relative positions of actors in an organization.

14. The system of claim 8, wherein the knowledge base comprises information concerning the role and attributes of the initiating actor.

15. The system of claim 8, wherein the knowledge base comprises information concerning the role and attributes of the at least one target actor.

16. The system of claim 1, wherein the action is implemented as an XLANG schedule.

17. The system of claim 1, wherein a second action can be combined with a first action to generate a workflow.

18. A method for generating an automated business process comprising:
receiving an action from an initiator, the action comprising at least one task;
receiving parameters associated with the at least one task from the initiator;
encapsulating the at least one task, the initiator and the parameters into an automated business process.

19. A method for generating an automated business process comprising:
receiving an action from an initiator, the action comprising at least one task;
receiving parameters associated with the at least one task from the initiator;
limiting the at least one task based on information associated with the initiator, the at least one task and the parameters;
encapsulating the limited at least one task, the initiator and the parameters into an automated business process.

20. The method of claim 19, further comprising executing the automated business process.

21. The method of claim 19, further comprising saving the automated business process as a practice.

22. The method of claim 19, wherein the action is a business practice.

23. The method of claim 19, wherein the action is initiated by the initiator using a user interface for an automated business process package.

24. The method of claim 19, wherein initiation of the action is triggered by cues detected within an external process.

25. The method of claim 19, wherein the external process is sending an e-mail.

26. The method of claim 19, wherein the action is a first action, the initiator is a first initiator, the automated business process is a first automated business process, a second action is received from a second initiator and the first action and the second action are combined to create a second automated business process.

27. The method of claim 19, further comprising receiving a delay indicator.

28. The method of claim 19, wherein further processing of the action is delayed until a message is received.

29. The method of claim 28, wherein the message is received when a triggering event has occurred.

30. The method of claim 29, wherein the triggering event is exceeding a timeout period.

31. A computer-readable medium on which is stored computer-executable instructions for:
receiving an action from an initiator, the action comprising at least one task;
receiving parameters associated with the at least one task from the initiator;
encapsulating the at least one task, the initiator and the parameters into an automated business process.

32. A constrained workflow system comprising:
an automated workflow system; and
a constraint system, the constraint system limiting the automated workflow system, the constrain system comprising:
a knowledge base for storing information concerning the initiating actor, the at least one target actor and the at least one task;
a constrainer that restricts at least one action and the set of parameters according to information stored in the knowledge base.

33. A method for generating a constrained automated business process comprising:
receiving an automated business process, the automated business process associated with an initiator and a target participant in the automated business process;
limiting the initiator and the target participant based on information associated with the initiator and the target participant stored in a knowledge base to generate a constrained automated business process.
